(19) United States
(12) Patent Application Publication
(10) Pub. No.: US 2018/0262349 A1
(43) Pub. Date: Sep. 13, 2018

(54) SYSTEM AND APPROACH TO DEPLOY SECURE COMMUNICATION FOR A NETWORK

(71) Applicant: Honeywell International Inc., Morris Plains, NJ (US)

(72) Inventors: Prabhat Ranjan, Bangalore (IN); Jerry Marti, West Salem, OH (US)

(21) Appl. No.: 15/457,855

(22) Filed: Mar. 13, 2017

(51) Int. Cl. H04L 9/32

(52) U.S. Cl. CPC H04L 9/3268

(57) ABSTRACT

A system and approach for making a communications network secure. The network may incorporate a supervisor, site controllers and other components applicable to, for example, building systems. A multi-site tool may be used to configure, setup and deploy secure communication channels and connections for the network. The tool is capable of providing batch changes in security configurations for a large number, for instance thousands, of controllers. A secure sockets layer deployment, among others, may be used for securing network communications.

### BACKGROUND

The present disclosure pertains to communications and particularly to secure communications.

### SUMMARY

The disclosure reveals a system and approach for making a communications network secure. The network may incorporate a supervisor, site controllers and other components applicable to, for example, building systems. A multi-site tool may be used to configure, setup and deploy secure communication channels and connections for the network. The tool is capable of providing batch changes in security configurations for a large number, for instance thousands, of controllers. A secure sockets layer deployment, among others, may be used for securing network communications.

### BRIEF DESCRIPTION OF THE DRAWING

FIGS. 1a, 1b, 1c and 1d constitute a workflow activity diagram for the present system and approach for an application of a secure sockets layer tool;

FIG. 2 is a diagram of a workflow for invoking a collection job;

FIG. 3 is a diagram of a workflow for generating a certificate signing request; and

FIG. 4 is a diagram of a workflow for a self-signing certificate.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

Aspects of the system or approach may be described in terms of symbols in the drawing. Symbols may have virtually any shape (e.g., a block) and may designate hardware, objects, components, activities, states, steps, procedures, and other items.

The Novar™ Opus™ supervisor and Opus XCMs may be the target applications to provide the present system and approach that is disclosed herein. A user of the Novar Opus Supervisor may manage and communicate with hundreds or thousands of remote site controllers from a centralized location through a corporate network. Each of these site controllers may be referred to as an XCM controller (XCM). The terms “XCM” and “site controller” may be used interchangeably. Each XCM in turn may manage and communicate with tens or hundreds of field controllers within the site that perform real time control of building equipment such as HVAC units, lighting panels, metering and refrigeration circuits. The Opus supervisor and XCMs may be configured for secure sockets layer (SSL) connections. An Opus architect may make connections to an XCM's station/platform based on a supervisor connection. If the Opus supervisor is connected using a SSL (secure) connection, then virtually all XCM station and platform connections may, by default, become SSL connections.

Often, a building management system (BMS) may not necessarily be designed with security in mind as these systems can be considered to be less vulnerable and away from a corporate network. With the recent development and security breaches that have been found, a focus on securing building automation system (BAS) has increased many fold. In many cases, security may have been bolted on to these systems. BAS commissioning engineers and programmers may not necessarily have prior experience with security in a BAS system. Moreover, security by its inherent nature, may bring complexity in deployment and configuration with which a BAS engineer with no expertise on the security domain does not want to deal. This issue may become huge for multi-site customers as they have to deal with thousands and thousands of stores. The Novar Opus Supervisor and XCM site controllers, which are Niagara™ based systems, may require creation and configuration of security certificates at the Supervisor and each XCM site controller to establish secure communications between the supervisor and a store. There may be multiple issues with the SSL deployment for a multi-site customer.

First, existing tools provided by Niagara framework for SSL certificate creation, signing and import, may be complex for BAS engineers to understand as it often required deep understanding and expertise about working of SSL. An existing workflow to setup SSL may involve a large number of steps that are very error prone. It has been observed many times that these configurations do not necessarily get set up correctly. Niagara does not necessarily provide a mechanism to convert certificates from one form to another. Niagara may generally just understand the “.pem” certificate file, and many of the customers may use different certificate formats. This situation may often require one to convert certificates using third party tools. Niagara does not necessarily provide a mechanism to deploy certificates in a batch across multiple sites. Each site may need to be configured separately. This could make SSL deployment very time consuming and resource intensive. Niagara does not necessarily provide a mechanism to centrally view and manage certificates across, for instance, all stores. Any information about certificates may be obtainable only after connecting to individual sites. There might be no notification mechanism for letting users know about a certificate expiration. The only way to know that a certificate has expired may be when a site stops communicating.

The present system and approach may solve all of the noted above issues by providing a user with a simple and easy to use an SSL deployment utility which automates all the manual configurations needed for SSL deployment as well as provide the user an ability to deploy the SSL across an enterprise with thousands of sites by using a simple wizard based system and approach. A purpose of the present system and approach may be to hide the intricate details about SSL configurations, reduce SSL configuration deployment time and eliminate configuration errors caused during an SSL deployment. Furthermore, the present system and approach may also provide users with an ability to centrally manage and monitor their enterprises for SSL connectivity and prior notification of a certificate expiry which could eliminate the down time.

The present system and approach may provide a solution to an issue outlined herein by providing the following product features and the necessary steps required to use these features. An Opus SSL tool may provide a new Opus SSL service with an intuitive interface having the following features.

One feature may be centralized certificate monitoring. The present system and approach may provide a user interface that can be used to monitor SSL deployment across an enterprise. This feature may meet a need for an enterprise to quickly visualize whether its stores have been correctly configured for SSL as well as provide an overview of the certificates deployed in an XCM with a certificate name, start date and end date for the certificate. Thus, it may be easier for a user to check if the site has been configured for SSL or not, and also determine if the correct certificates have been installed. For one or more other systems to get this information, an operator may have to log in to each individual XCM to get these details, which for a large enterprise with thousands of site controllers can be very time consuming. The present system may provide a mechanism by which a collection job can be run manually or triggered using a schedule which would collect SSL certificate details from all of the XCM's and persist this information in a Niagara bog file.

Another feature may be automatic notification about certificate expiry. The present system and approach may provide an automatic email notification about the certificates that are going to expire. The notification may allow a user to configure a number of days before the certificate expiry about which the user would like to get notified as well as the frequency of the notification. One or more other systems may have a severe limitation in that a user is not notified in advance that the certificate is going to expire. One way in such a situation that a user may get to know is when a store stops communicating to the supervisor. This lack of communication may lead to serious issues. Knowing about certificate expiry in advance may let a user obtain a new certificate and configure the site controller before an expiry occurs. This system and approach may reduce or prevent any down time and connectivity issues.

Still another feature may be SSL deployment and configuring stores for secure communications. SSL may be configured for store-to-supervisor communication using several different ways. One may be having self-signed certificates. In this case, a certificate's private key may be used to sign its own certificate. This type of signature is not necessarily recommended to secure a server because its trust cannot be verified. The present system and approach may prevent a user from using this type of certificate.

Another feature may be a certificate signed using one's own certificate authority (CA). If a customer network is self-contained, and is not exposed to the internet, this configuration may be used. When a company serves as its own CA, a certificate signed by the private key may be associated with one of its CA certificates (the root certificate). This type of certificate management may be used by a small enterprise who does not have an infrastructure for certificate management and who does not want to bear the extra cost for a third-party CA.

The present system and approach may provide a mechanism by which a root certificate/CA may be created. Once a root certificate is created, the SSL tool may allow a user to select the stores which need to be configured for SSL connectivity and then present the user an option to configure an SSL using the CA. Once the user selects the CA, the user may choose to import the certificates. The SSL tool may then connect to all the individual XCM's that have been selected by user and do the following things automatically which otherwise would have to be done manually for each XCM.

First may be to create a server certificate for the selected XCM's based on the hostname specified in the Niagara station in the supervisor Niagara network. Second may be to create a certificate signing request (CSR) for the server certificate. Third may be to sign the server certificate with selected CA's private key. Fourth may be to import the CA certificate into the trust store of the selected XCM. Fifth may be to import the signed server certificate into the key store of selected XCM. Sixth may be to configure the XCM station (fox service, web service) and platform service for the newly created certificate by selecting the newly configured server certificate.

All the above steps may be repeated for all of the selected XCM's and the user may be provided with a progress screen which shows iteratively what is being done. At the end of the process, all of the needed configurations for SSL may be completed for all sites selected by the user.

Certificates may be signed using third party certificate authority (CA). If one's network is exposed to the internet, a third-party CA may provide the most secure communication, however, at a cost. This deployment model may be used by large enterprises which have a necessary infrastructure and IT knowledge required for certificate management.

The present system and approach may provide a mechanism by which this SSL deployment process can be done easily for multiple sites at the same time. An Opus SSL tool may provide a mechanism by which a user can select the sites and XCM's for configuring an SSL. The user may then be presented with an option to select the certificate deployment using a third party CA. This may be achieved using a two-step process where user first selects an option to create a certificate signing request (CSR) for all the selected XCM's. During one step of a process, one may create a server certificate for the selected XCM's based on the hostname specified in the Niagara station in the supervisor Niagara network, and create a certificate signing request (CSR) for the server certificate and store the CSR file in the Niagara home directory under the Opus certificate manager.

CSR's created by the above process may then be sent to the certificate authority (CA) for signing. Once signing is completed by the CA, a list of signed certificates may then be returned back which needs to be placed in the signed certificate folder for each XCM inside the Niagara home Opus certificate manager folder. The Opus SSL tool may remember the user's previous selection of sites, and after all of the signed certificates have been placed in the appropriate folders, the user may select the import option in the tool. The act of the user's selecting an import option may do following items automatically. That would be to import the CA certificate from the Opus certificate manager folder into the trust store of the selected XCM, import the signed server certificate from the folder into the key store of the selected XCM, and configure an XCM station (fox service, web service) and platform service for a newly placed signed certificate by selecting the newly configured server certificate.

In an automatic certificate conversion, there are several different file formats that may be used to hold certificates and their private keys each with their own benefits. The Niagara system may mandate a use of PEM certificate files. However, many customers may use other formats like PKCS #7 B(P7B), PKCS#12, .cer, .crt, and so on. These different format certificates may have to be converted into a .pem format before they can be imported for an SSL configuration. In systems, other than the present one, this conversion may necessitate the use of open source tools like OpenSSL to convert the certificate from one form to other. This conversion may be very confusing for the operator who is assigned with a task for SSL deployment. The Opus SSL tool may hide this complexity from the user and do the conversion automatically on the user's behalf after the signed certificate in any format is placed under the signed server certificate folder inside the Niagara home Opus certificate manager folder. This apart from hiding the complexity may eliminate the use of third party tools.

The user may utilize the present system and approach as a new feature available in Opus supervisor applications. The following activities may be followed. The user may install an Opus supervisor version 5.11.145 or later. This version of the supervisor may have the Opus SSL service preinstalled with configuration options to configure a collection job, default certificate properties and email configurations for notifications. The Opus SSL collection job may be either configured to run manually or be triggered using a timer. The Opus collection job may connect to all XCMs in the Niagara network of the Supervisor and collect information about the deployed certificates in the XCM and save this information in a local version database file. After this job has been executed, the user may see all of the XCMs along with certificate information for all of the deployed site XCM controllers in the Opus Certificate Overview screen. The Opus collection job may also create a CSV file containing all of the XCM's, whose certificate is going to expire in a configured number of days, to all email recipients configured in the email configuration of the Opus SSL service.

Once in the certificate overview screen, the user may select the option to configure SSL. To setup a new SSL configure job, the user may easily select the target site XCM controllers by selecting group, site and the XCM to be configured. Once the target XCM's are selected, the user then may be prompted to select the SSL configuration type. The user may select from the options, configure the SSL with the CA or configure the SSL with a self-signed CA. Once the configuration type is selected, the user may submit the job for execution. The user may be shown the currently running job execution steps for processing. The user may navigate away from the running job to perform other duties and return later to review statuses.

When an SSL configuration job is submitted to be run, the selected SSL configuration type may dictate the execution path.

If the user is performing a SSL configuration with a self-signed CA, then the user may have to select the CA that will be used for signing the certificates. After the job is submitted, the Supervisor may first connect to the XCM and then create a server certificate using the properties configured for a default certificate in the Opus SSL service. It may then create a certificate signing request and sign the certificate with the provided CA's private key. These signed certificates may then be configured in the fox service, web service in the Niagara station for station-to-station communication, and be configured in the platform service for secure platform communication.

If the user chooses to configure the SSL using a third party CA, then the user may be presented with an option to generate a certificate signing request (CSR) for the selected XCM's. These CSR files may be stored in the local directory which can be sent to a third party CA for signing the certificate folder. Once the signing process is complete, all of the signed certificates may be placed in a proper location in the local directory. After this step, the user may choose to import these signed certificates. Steps that would be followed for importing the signed certificates are similar to the approach that is used for importing self-signed certificates with the only difference that, during this process, the signed certificates may be imported from the file location. In this process, if the signed certificate received from the CA is of a different format than a PEM format, then the SSL tool may automatically convert the certificates from another format to a PEM format so that it can be imported into the Niagara key store and trust store.

In all of the job operation executions, the detailed operation steps taken during the job execution may be shown to the user. Also, when an SSL configuration operation is complete, the user may opt to ping and verify SSL connectivity across XCM for a sanity check.

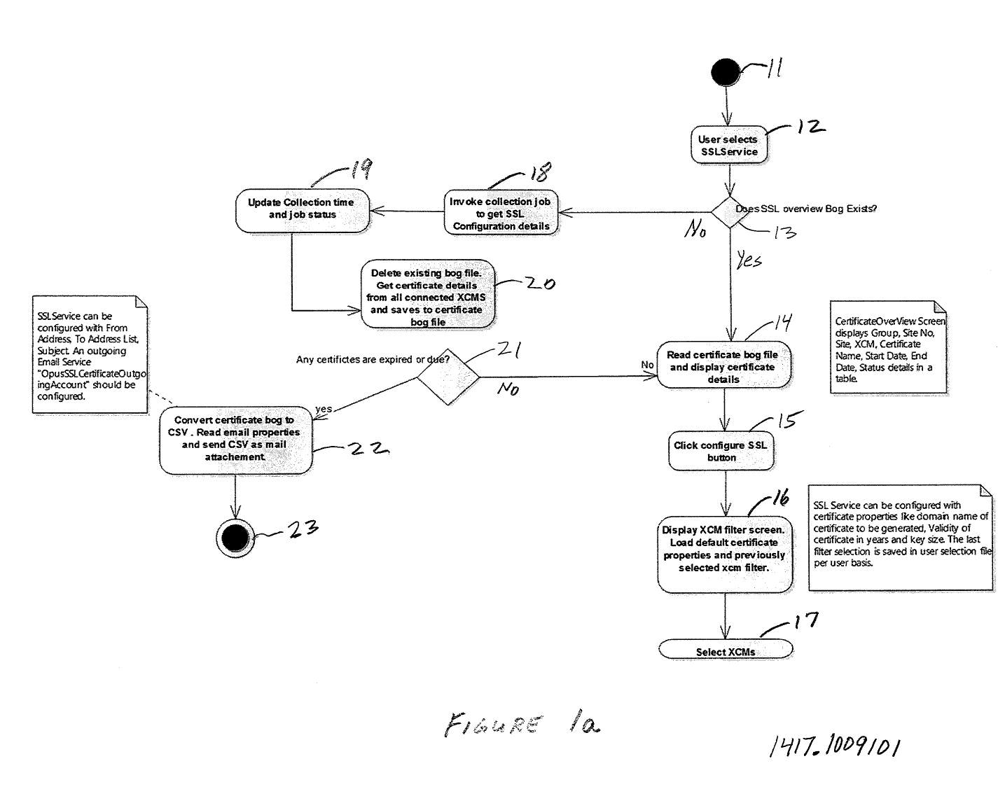

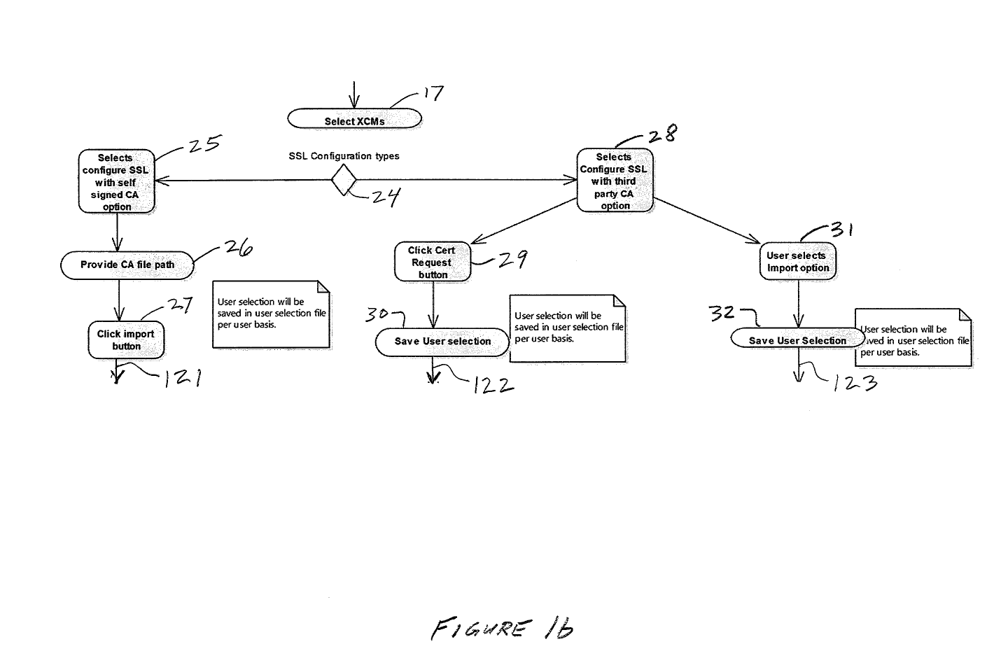

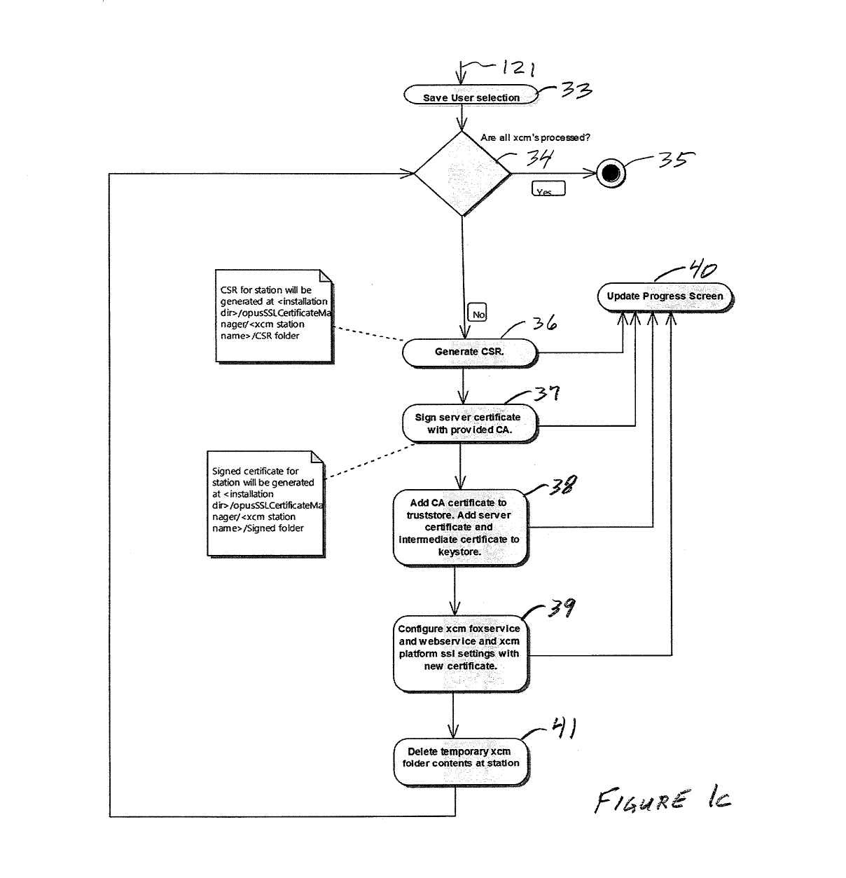

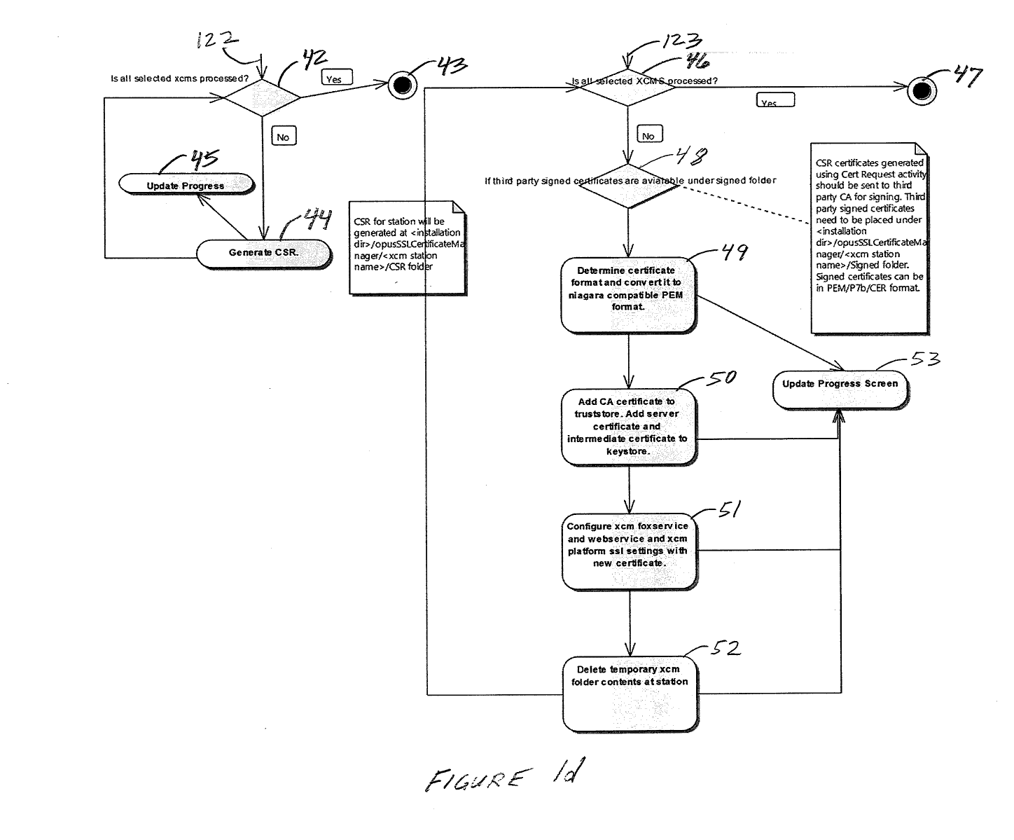

FIGS. 1a, 1b, 1c and 1d constitute a workflow activity diagram for the present system and approach for an Opus SSL tool. From a start at symbol 11 in FIG. 1a, a user may select an SSL service at symbol 12. A question at symbol 13 may be whether an SSL overview bog exists. If an answer is yes, then read a certificate bog file and display certificate details according to symbol 14. A certificate overview screen may display group, site no., site, XCM, certificate name, start date, end date, and status details in a table. In symbol 15, one may be directed to click a configure SSL button. After that, an XCM filter screen may be displayed, and default certificate properties and the previously selected XCM filter may be loaded at symbol 16. SSL service may be configured with certificate properties like a domain name of a certificate to be generated, validity of the certificate in years and key size. The last filter selection may be saved in a user selection file per user basis. XCM's may be selected at symbol 17. A continuation of this work flow is noted in FIG. 1b with common symbol 17.

If the answer to the question at symbol 13 is no, then at symbol 18, one may invoke a collection job to get SSL configuration details. Collection time and job status may be updated as indicated at symbol 19. At symbol 20, one may delete the existing bog file, and get certificate details from all corrected XCM's and save them to a certificate bog file. A question of whether any certificates are expired or due may be asked at symbol 21. If an answer is yes, then at symbol 22, the certificate bog may be converted to CSV. Also, the email properties may be read and the CSV may be sent as a mail attachment. SSL service may be configured with a from address, to address list, and subject. An outgoing email service “Opus SSL Certificate Outgoing Account” should be configured. After symbol 22, one may stop at symbol 23. If the answer to the question at symbol 21 is no, then one may go and continue the flow from symbol 14.

In FIG. 1b, after selecting XCM's at symbol 17, an SSL configuration type may be selected at symbol 24. One selection may be a configuration with a self-signed CA at symbol 25. A CA file path may be provided as noted by symbol 26. An import button may be clicked on at symbol 27. This flow may be continued in FIG. 1c with a common line 121.

At symbol 24, a configuration SSL with a third party CA option may be selected at symbol 28. At symbol 29, one may click a certificate request button and then save a user selection as indicated by symbol 30. The user selection may be saved in a user selection file per user basis. A continuation of this workflow is shown in FIG. 1d with a common line 122.

After symbol 28, the user may select an import option at symbol 31. The user selection may be saved according to symbol 32. The user selection may be saved in a user selection file per user basis. A continuation of this workflow may be shown in FIG. 1d with a common line 123.

After clicking the import button at symbol 27 of FIG. 1b, the user selection may be saved as indicated by symbol 33 in FIG. 1c. A question at symbol 34 is whether all of the XCM's have been configured. If an answer is yes, then this work flow may end at symbol 35. If the answer is no, then a CSR may be generated at symbol 36. The CSR may be generated at an <installation dir>/Opus SSL Certificate Manager/<XCM station name>/CSR folder. A server certificate with a provided CA may be signed, as noted at symbol 37. A signed certificated may be generated at <installation dir>/Opus SSL Certificate Manager/<XCM station name>/Signed folder. Symbol 38 indicates that a CA certificate may be added to a trust store. Also, a server certificate and an intermediate certificate may be added to a key store. As noted in symbol 39, one may configure XCM fax service and web service, and XCM platform SSL settings with a new certificate. The actions in symbols 36, 37, 38 and 39 may be reported to update a progress screen indicated by symbol 40. At symbol 41, temporary XCM folder contents at the station may be deleted. One may return from symbol 41 to symbol 34 to ask the question of whether all of the XCM's are configured. Each answer may follow the workflow as indicated herein.

In FIG. 1d, symbol 42 that follows symbol 30 of the Figure may show a question of whether all selected XCM's have been processed. If an answer is yes, then the work flow may end at symbol 43. If the answer is no, then a CSR may be generated at symbol 44. The CSR for a station may be generated at <installation dir>/Opus SSL Certificate Manager/<XCM station name>/CSR folder. The action at symbol 44 may be provided as an update of progress at symbol 45 for a CSR check progress screen. After generating the CSR at symbol 44, one may return to ask the question at symbol 42, where the work flows to the answers are noted herein.

After symbol 32 in FIG. 1c, may follow a symbol 46 asking whether all of the selected XCM's have been processed. If an answer is yes, then the work flow may end at symbol 47. If the answer is no, then a question of whether third party sign certificates are available under a signed folder at symbol 48. CSR certificates generated using cert request activity should be sent to a third party CA for signing. Third party signed certificates need to be placed under <installation dir>/Opus SSL Certificate Manager/<XCM station name>/Signed folder. Signed certificates may be in a PEM/p7o/CER format. The certificate format may be determined and the certificate format can be converted to a Niagara compatible PEM format at symbol 49. At symbol 50, the CA certificate may be added to the trust store. The server certificate and the immediate certificate may be added to the key store. Symbol 51 indicates that one may configure the XCM fox service and web service, and the XCM platform SSL settings with a new certificate. After symbol 51, temporary XCM folder contents at the station may be deleted. After symbol 52, a return may be made to symbol 46 so as to repeat the workflow as needed.

Information from symbols 49, 50, 51 and 52 may be provided to update a progress screen at symbol 53 to import a check progress screen.

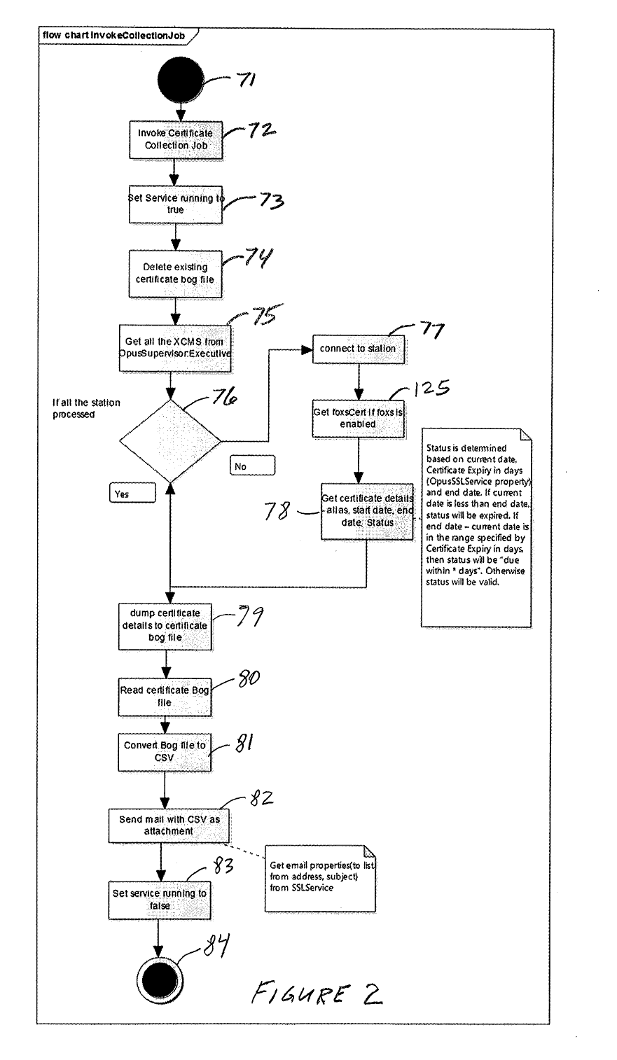

FIG. 2 is a diagram of a work flow for invoking a collection job which may start at symbol 71 and go to symbol 72 where a certificate collection job may be invoked. The service running may be set to true at symbol 73. The existing certificate bog file may be deleted as indicated by symbol 74. All of the XCM's may be obtained from an Opus Supervisor Executive according to symbol 75. At symbol 76 is a question of whether all of the stations have been processed. If the answer is no, then one may connect to the unprocessed station at symbol 77 and get a fox service certification if fox service is enabled at symbol 125. Then one may get certificate details—alias, start date, end date and status at symbol 78. Status may be determined based on a current date, Certificate Expiry in days (Opus SSL service property) and end date. If the current date is less than the end date, the status will be expired. If the end date—current date is in the range specified by Certificate Expiry in days, then the status will be “due within days”. Otherwise the status will be valid. Then one may go to symbol 79. If the answer to the question at symbol 76 is yes, then one may go to symbol 79, where the certificate details are dumped to the certificate bog file.

The certificate bog file may be read at symbol 80. The bog file may be converted to CSV at symbol 81. Mail may be sent with CSV as an attachment at symbol 82. One may get email properties (to list, from address, subject) from SSL service. The service may be set to running to false at symbol 83. This workflow may end at symbol 84.

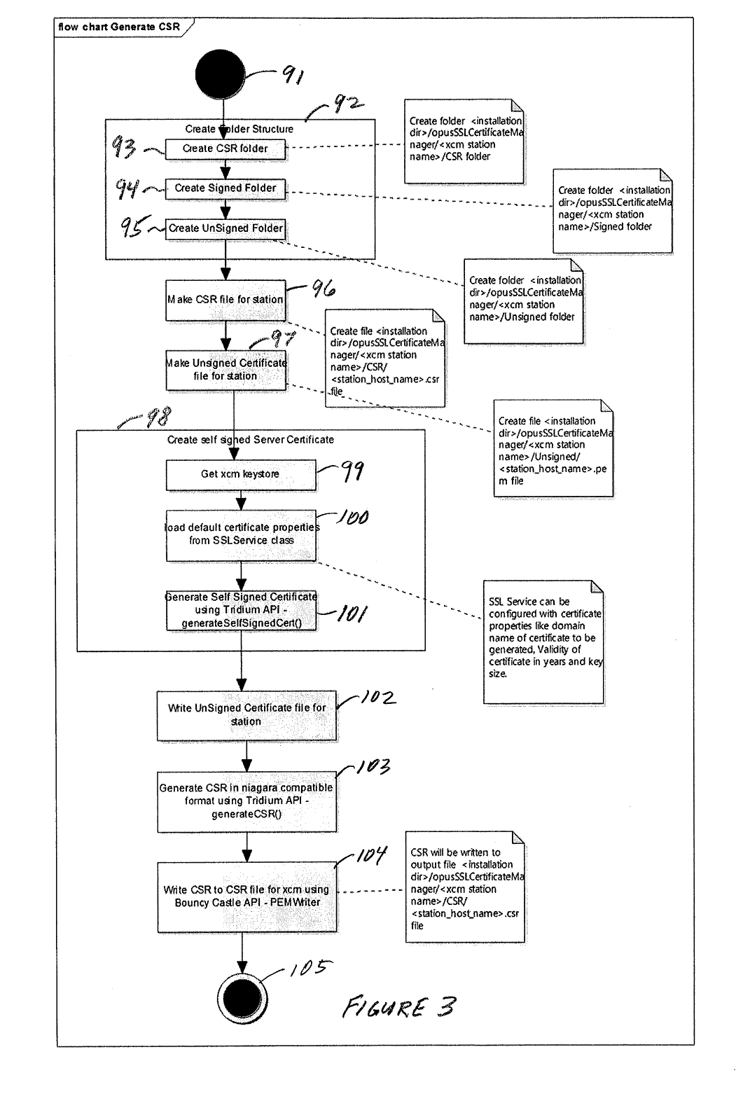

FIG. 3 is a diagram of a workflow for generating a CSR, which may start at symbol 91. A folder structure may be created within symbol 92. Symbol 93 may be creating a CSR folder. The created folder may be at <installation dir>/Opus SSL Certificate Manager/<XCM station name>/CSR folder. Symbol 94 may be creating a signed folder. This may be at <installation dir>/Opus SSL Certificate Manager/<XCM station name>/Signed folder. An unsigned folder may be created at symbol 95. This may be at <installation dir>/Opus SSL Certificate Manager/<XCM station name>/Unsigned folder. Leaving symbol 92, one may make a CSR file for a station at symbol 96. For a create file, this may be at <installation dir>/Opus SSL Certificate Manager/<XCM station name>CSR/<station_host_name>/CSR file. An unsigned certificate may be made for the station at symbol 97. This may be at <installation dir>/Opus SSL Certificate Manager/<XCM station name>/Unsigned/station_host_name>.pem file.

A self signed service certificate may be made within symbol 98. One may get an XCM key store at symbol 99. At symbol 100, default certificate properties may be loaded from an SSL Service class. The SSL Service may be configured with certificate properties like a domain name of a certificate to be generated. The validity of the certificate may be in years and key size at symbol 101. A self signed certificate may be generated using Tridium API at generate self signed Cert( ).

From symbol 101 within symbol 98, one may go to symbol 102 to write an unsigned certificate for the station. A CSR may be generated in a Niagara compatible format using Tridium API at generate CSR( ) as indicated in symbol 103. One may write CSR to a CSR file for XCM using Bouncy Castle API at PEM writer, as indicated by symbol 104. This work flow may end at symbol 105. CSR may be written to output file <installation dir>/Opus SSL Certificate Manager/<XCM station name>/CSR/>station_host_name>CSR file.

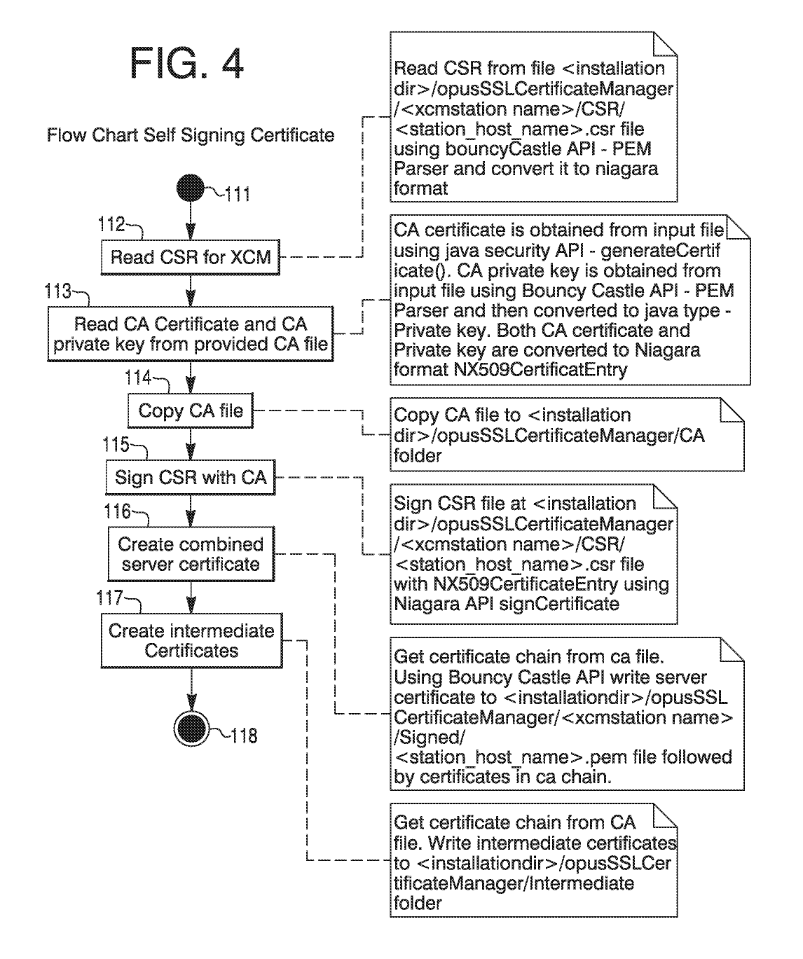

FIG. 4 is a diagram of a work flow for a self-signing certificate, beginning at symbol 111. The CSR may be read for an XCM at symbol 112. CSR may be read from file <installation dir>/Opus SSL Certificate Manager/<XCM station name>/CSR/<station_host_name>.CSR file using Bouncy Castle API-PEM parser and convert it to a Niagara format. At symbol 113, one may read a CA certificate and CA private key from a provided CA file. The CA certificate may be obtained from input file using java security API—generate Certificate( ). A CA private key may be obtained from an input file using Bouncy Castle API-PEM Parser and then converted to a java type—Private Key. Both the CA certificate and Private key may be converted to a Niagara form at NX509 Certificate Entry. At symbol 114, the CA file may be copied. The file may be copied to <installation dir>/Opus SSL Certificate Manager/CA folder. At symbol 115, the CSR may be signed with a CA. The signed CSR file may be at <installation dir>/Opus SSL Certificate Manager/<XCM station name>/CSR/<station_host_name>/CSR file with NX509 Certificate Entry using Niagara API sign Certificate. At symbol 116, a combined server certificate may be created. One may get a certificate chain from a CA file, using a Bouncy Castle API write server certificate to <installation dir>/Opus SSL Certificate Manager/<XCM station name>/Signed/<station_host_name>/.pem file followed by certificates in a CA chain. Intermediate certificates may be created at symbol 117. One may get the certificate chain form the CA file. Intermediate certificates may be written to <installation dir>/opus SSL Certificate Manager/Intermediate folder. This work flow may end at symbol 118.

To recap, a mechanism of secure communications deployment across many controllers, may incorporate a supervisor, and a plurality of site controllers having stations and platforms. The stations and platforms may be connected to the supervisor. Connections to stations and platforms of the site controllers may be based on a supervisor connection. The supervisor connection may be a secure sockets layer (SSL) connection. Since the supervisor connection is an SSL connection, then the connections of the stations and platforms of the site controllers may be SSL connections by default.

The supervisor and site controllers may have SSL security certificates to establish the SSL connections for secure communications.

An SSL deployment utility may automate all manual configurations needed for SSL deployment of the SSL connections with a wizard based system that hides details about SSL configurations from a user. The SSL deployment utility may provide a user an ability to centrally manage or monitor an enterprise for the SSL connections. The enterprise may incorporate the supervisor and the plurality of site controllers.

Each site controller may manage or communicate with a plurality of field controllers that provide real time control of building equipment.

The SSL deployment utility may incorporate a collection job. The collection job may run manually or may be triggered by a schedule, and collect SSL certificate details from the site controllers and persist the details in a bog file.

The SSL deployment utility may provide an automatic notification to a recipient about a certificate having an expiration date. The automatic notification may be configured to provide the notification at a predetermined amount of time before an expiration date of the certificate or a frequency of the notification. The notification provided about the expiration date before an occurrence of the expiration date may permit a user to review the certificate or configure a site controller to which the expiration date pertains.

The SSL deployment utility may configure a supervisor and site controller communication with one or more certificates selected from a group incorporating a self-signed certificate that is signed by the certificate's private key, a certificate signed with a certificate authority of the enterprise in that the certificate is signed by a private key which is associated with one of the enterprise's certificate authority certificates, that is, a root certificate, a certificate signed with a third-party certificate authority.

The SSL deployment may be done for a plurality of site controllers at the same time. A user may select the site controllers for configuring with SSL. A user may select an option to select a certificate deployment using a third party certificate authority. The user may select an option to create a certificate signing request (CSR) for selected site controllers.

A server certificate may be created for the selected site controllers based on a hostname specified in a Niagara′ station in the supervisor Niagara™ network. A certificate signing request may be created for the server certificate and the certificate signing request may be stored. The created certification signing request (CSR) may be sent to a certificate authority for signing. After the signing is completed, a list of one or more signed certificates may be stored in a certificate folder.

The user may select an import option in the SSL deployment tool to automatically import a certification authority certificate from the certificate folder into a trust store of a selected site controller, import a signed certificate from the certificate folder, placing the signed certificate in a local directory. The user may choose to import the signed certificates in a process similar to that for importing self-signed certificates with a difference in that the signed certificates are imported from the file location. If a signed certificate received from the certificate authority has a non-PEM format, then the SSL tool may automatically convert the signed certificates having the non-PEM format to a PEM format so that the signed certificate can be imported into a Niagara™ key store or trust store.

A secure connectivity system may incorporate a supervisor and site controllers. The supervisor and the site controllers may be configured for secure sockets layer (SSL) connections. Each of the site controllers may communicate with one or more field controllers. The one or more field controllers may perform control of equipment in a building. The SSL connections between the supervisor and the site controllers may be configured with a multi-site tool. The multi-site tool may provide batch changes of security configurations

The system may further incorporate a user interface to monitor SSL deployment across the supervisor and site controllers, to check whether a site controller has been configured for SSL, to determine whether correct security certificates have been installed, and to indicate expiration dates of security certificates prior to occurrences of the expiration dates, respectively. The system may further incorporate a configuration of SSL connections based on security certificates.

Security certificates may be approved upon being signed. A security certificate may be signed in a way selected from a group incorporating a self-signed certificate which is signed with a certificate's private key, a certificate signed using a certificate authority that is a certificate signed by a private key associated with one or more certificate authority certificates such as a root certificate of a company that owns the root certificate, and a certificate signed using a third-party certificate authority.

The certificate signed by using a third party certificate authority may incorporate a user presented with an option to generate a certificate signing request (CSR) for a selected XCM. The CSR file may be stored in the local directory which is sent to a third party certificate authority for signing a certificate. Once the signing process is complete, the signed certificate may be placed in the local directory.

A secure sockets layer deployment system, may incorporate a supervisor, one or more site controllers connected to the supervisor, and one or more field controllers connected to the one or more site controllers. The supervisor and site controllers may be configured for secure sockets layer (SSL) connections. When the supervisor is connected using an SSL connection, then the site controller connections may become SSL connections.

A field controller may perform real-time control of building equipment. The building equipment may incorporate one or more items selected from a group having HVAC units, lighting panels, refrigeration units, and metering circuits.

An SSL utility automated manual configuration may be required for SSL deployment, and provide a user's ability to deploy an SSL across an enterprise of many sites, using a wizard approach.

A user may centrally manage and monitor SSL connectivity and receive notification of a certificate expiration for a predetermined period of time before expiration of a certificate.

The system may further incorporate a user interface for monitoring SSL deployment. The user interface may provide an overview of certificates deployed in site controllers. Each certificate may have a name, a start date and an end date.

The user interface may provide a collection job that uses a schedule to collect SSL certificate details from the site controllers and persist the details in a file.

Any publication or patent document noted herein is hereby incorporated by reference to the same extent as if each publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A mechanism of secure communications deployment across many controllers, comprising:
a supervisor; and
a plurality of site controllers having stations and platforms; and
wherein:
the stations and platforms are connected to the supervisor;
connections to stations and platforms of the site controllers are based on a supervisor connection;
the supervisor connection is a secure sockets layer (SSL) connection; and
since the supervisor connection is an SSL connection, then the connections of the stations and platforms of the site controllers are SSL connections by default.

2. The mechanism of claim 1, wherein the supervisor and site controllers have SSL security certificates to establish the SSL connections for secure communications.

3. The mechanism of claim 1, wherein:
an SSL deployment utility automates all manual configurations needed for SSL deployment of the SSL connections with a wizard based system that hides details about SSL configurations from a user;
the SSL deployment utility provides a user an ability to centrally manage or monitor an enterprise for the SSL connections; and
the enterprise comprises the supervisor and the plurality of site controllers.

4. The mechanism of claim 3, wherein each site controller manages or communicates with a plurality of field controllers that provide real time control of building equipment.

5. The mechanism of claim 3, wherein:
the SSL deployment utility comprises a collection job;
the collection job runs manually or is triggered by a schedule and collects SSL certificate details from the site controllers and persists the details in a bog file.

6. The mechanism of claim 3, wherein:
the SSL deployment utility provides an automatic notification to a recipient about a certificate having an expiration date;
the automatic notification is configured to provide the notification at a predetermined amount of time before an expiration date of the certificate or a frequency of the notification; and
the notification provided about the expiration date before an occurrence of the expiration date permits a user to review the certificate or configure a site controller to which the expiration date pertains.

7. The mechanism of claim 3, wherein the SSL deployment utility configures a supervisor and site controller communication with one or more certificates selected from a group comprising:
a self-signed certificate that is signed by the certificate's private key;
a certificate signed with a certificate authority of the enterprise, wherein the certificate is signed by a private key that is associated with one of the enterprise's certificate authority certificates, that is, a root certificate; and
a certificate signed with a third-party certificate authority.

8. The mechanism of claim 3, wherein:
the SSL deployment can be done for a plurality of site controllers at the same time;
a user selects the site controllers for configuring with SSL;
a user selects an option to select a certificate deployment using a third party certificate authority; and
the user selects an option to create a certificate signing request (CSR) for selected site controllers.

9. The mechanism of claim 8, wherein:
a server certificate is created for the selected site controllers based on a hostname specified in a Niagara™ station in the supervisor Niagara™ network;
a certificate signing request is created for the server certificate and the certificate signing request is stored.
the created certification signing request (CSR) is sent to a certificate authority for signing; and
after the signing is completed, a list of one or more signed certificates is stored in a certificate folder.

10. The mechanism of claim 9, wherein:
the user selects an import option in the SSL deployment tool to automatically import a certification authority certificate from the certificate folder into a trust store of a selected site controller, import a signed certificate from the certificate folder, placing the signed certificate in a local directory;
the user can choose to import the signed certificates in a process similar to that for importing self-signed certificates with a difference in that the signed certificates are imported from the file location; and
if a signed certificate received from the certificate authority has a non-PEM format, then the SSL tool automatically converts the signed certificates having the non-PEM format to a PEM format so that the signed certificate can be imported into a Niagara™ key store or trust store.

11. A secure connectivity system comprising:
a supervisor; and
site controllers; and
wherein:
the supervisor and the site controllers are configured for secure sockets layer (SSL) connections;
each of the site controllers communicate with one or more field controllers;
the one or more field controllers perform control of equipment in a building;
the SSL connections between the supervisor and the site controllers are configured with a multi-site tool; and
the multi-site tool can provide batch changes of security configurations.

12. The system of claim 11, further comprising:
a user interface to monitor SSL deployment across the supervisor and site controllers, to check whether a site controller has been configured for SSL, to determine whether correct security certificates have been installed, and to indicate expiration dates of security certificates prior to occurrences of the expiration dates, respectively; and
a configuration of SSL connections based on security certificates.

13. The system of claim 12, wherein:
security certificates are approved upon being signed; and
a security certificate is signed in a way selected from a group comprising a self-signed certificate which is signed with a certificate's private key, a certificate signed using a certificate authority that is a certificate signed by a private key associated with one or more certificate authority certificates such as a root certificate of a company that owns the root certificate, and a certificate signed using a third-party certificate authority.

14. The system of claim 13, wherein the certificate signed by using a third party certificate authority comprises:
a user presented with an option to generate a certificate signing request (CSR) for a selected XCM; and
wherein:
the CSR file is stored in the local directory which is sent to a third party certificate authority for signing a certificate; and
once the signing process is complete, the signed certificate is placed in the local directory.

15. A secure sockets layer deployment system, comprising:
a supervisor;
one or more site controllers connected to the supervisor; and
one or more field controllers connected to the one or more site controllers; and
wherein:
the supervisor and site controllers are configured for secure sockets layer (SSL) connections; and
when the supervisor is connected using an SSL connection, then the site controller connections become SSL connections.

16. The system of claim 15, wherein:
a field controller performs real-time control of building equipment; and
the building equipment comprises one or more items selected from a group comprising HVAC units, lighting panels, refrigeration units, and metering circuits.

17. The system of claim 15, wherein an SSL utility automated manual configuration is required for SSL deployment, and provides a user's ability to deploy an SSL across an enterprise of many sites, using a wizard approach.

18. The system of claim 15, wherein a user can centrally manage and monitor SSL connectivity and receive notification of a certificate expiration for a predetermined period of time before expiration of a certificate.

19. The system of claim 15, further comprising:
a user interface for monitoring SSL deployment; and
wherein:
the user interface provides an overview of certificates deployed in site controllers; and
each certificate has a name, a start date and an end date.

20. The system of claim 19, wherein the user interface provides a collection job that uses a schedule to collect SSL certificate details from the site controllers and persists the details in a file.
